(19) United States
(12) Patent Application Publication
(10) Pub. No.: US 2026/0170132 A1
(43) Pub. Date: Jun. 18, 2026

(54) DATA MOVEMENT ARCHITECTURE FROM UNTRUSTED ZONE TO TRUSTED ZONE

(71) Applicant: Snowflake Inc., Bozeman, MT (US)

(72) Inventor: Piyush Singal, Fremont, CA (US)

(21) Appl. No.: 18/982,166

(22) Filed: Dec. 16, 2024

(51) Int. Cl. G06F 21/56

(52) U.S. Cl. CPC G06F 21/56; G06F 2221/034

(57) ABSTRACT

Techniques for facilitating data transfer from a deployment in an untrusted zone to a deployment in a trusted zone are described. In the cloud storage location in the trusted zone, the data may be arranged in an external table. The data can be scanned for malicious content by the data system in a more efficient manner because the data is arranged in the external table. After scanning is complete and no malicious content is detected, the data can be transferred to a secure account in the deployment in the trusted zone before it can be transmitted to other parts of the data system, providing another layer of security.

### TECHNICAL FIELD

Embodiments of the disclosure relate generally to cloud data platforms and, more specifically, to data movement from untrusted zones to trusted zones.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

A data platform may store database data (e.g., a table) in multiple storage units, which may be referred to as partitions, micro-partitions, and/or by one or more other names. A database may be organized as records (e.g., rows or a collection of rows) that each include one or more attributes (e.g., columns). In an example, multiple storage units of a database can be stored in a block and multiple blocks can be grouped into a single file. That is, a database can be organized into a set of files where each file includes a set of blocks, where each block includes a set of more granular storage units such as partitions. It should be understood that the terms “row” and “column” are used for illustration purposes and these terms are interchangeable. For example, data arranged in a column of a table can similarly be arranged in a row of the table.

A data platform can be organized in different deployments. For example, deployments may be arranged based on factors, such as geographic location and cloud service provider. When two deployments are located in a trusted zone (e.g., U.S., Europe), communication between the deployments can be relatively free of restrictions. However, when a deployment is located in an untrusted zone (e.g., China), communication to and from that deployment may be restricted.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a cloud data platform, according to some example embodiments.

FIG. 2 is a block diagram illustrating components of a compute service manager of the cloud data platform, according to some example embodiments.

FIG. 3 shows an example multiple deployment environment, according to some example embodiments.

FIG. 4 shows an example multiple deployment environment in trusted and untrusted regions, according to some example embodiments.

FIG. 5 shows an example multiple deployment environment with communication between trusted and untrusted zones, according to some example embodiments.

FIG. 6 is a flow diagram of a method for exporting data from an untrusted zone, according to some example embodiments.

FIG. 7 shows an example of a columnar storage format conversion, according to some example embodiments.

FIG. 8 is a flow diagram of a method for importing data from an untrusted zone, according to some example embodiments.

FIG. 9 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Typically, database systems (also referred to as data systems or cloud data platforms) are provided in areas where different deployments of the database system can communicate freely with each other. For example, a deployment on the east coast of the United States can communicate with a deployment on the west coast of the United States without any restrictions. However, some deployments may be provided in untrusted zones where communication to and from those deployments may be restricted. For example, firewalls may prevent direct communication. Data from these deployments in untrusted zones may be deemed untrusted, and, therefore, data originating from these deployments may be classified as untrusted data.

Aspects of the present disclosure address the foregoing issues, among others, with a data platform, systems, methods, and devices that facilitate data transfer from a deployment in an untrusted zone to a deployment in a trusted zone. Data to be transferred may be converted into a columnar storage format, where metadata relating to table data can be packetized together. A custom replication may be performed between two different cloud storage locations outside of the data system to transfer the data from the untrusted zone to the trusted zone. In the cloud storage location in the trusted zone, the data may be arranged in an external table. The data can be scanned for malicious content by the data system in a more efficient manner because the data is arranged in the external table. After scanning is complete and no malicious content is detected, the data can be transferred to a secure account in the deployment in the trusted zone before it can be transmitted to other parts of the data system, providing another layer of security. These techniques provide an efficient manner for egressing data from an untrusted zone while providing safety safeguards to protect the data system at multiple levels.

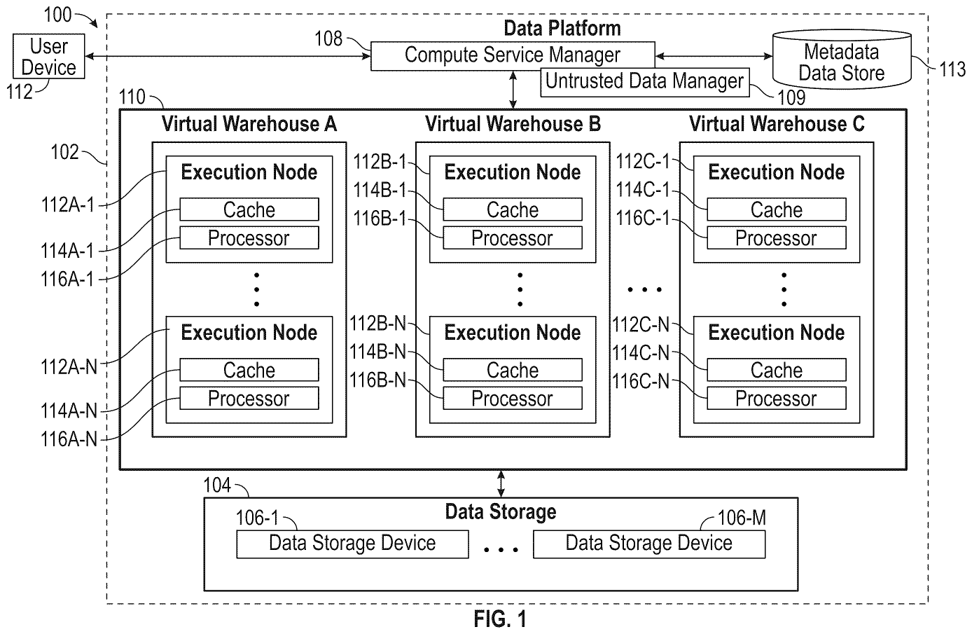

FIG. 1 illustrates an example computing environment 100 that includes a cloud data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the cloud data platform 102 comprises a three-tier architecture: a compute service manager 108 coupled to a metadata data store 113, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 113. The metadata data store 113 stores metadata pertaining to various functions and aspects associated with the cloud data platform 102 and its users. The metadata data store 113 also includes a summary of data stored in data storage 104 as well as data available from local caches. Additionally, the metadata data store 113 includes information regarding how data is organized in the data storage 104 and the local caches.

As shown, the compute service manager 108 includes an untrusted data manager 109 that is responsible for managing untrusted data, such as data from untrusted zones. Further details of the operation of the untrusted data manager 109 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata data store 113. The metadata data store 113 stores metadata pertaining to various functions and aspects associated with the cloud data platform 102 and its users. The metadata data store 113 also includes a summary of data stored in data storage 104 as well as data available from local caches. Additionally, the metadata data store 113 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B-1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 113 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 113, execution platform 110, and data storage 104 are shown in FIG. 1 as individual discrete components. However, each of the compute service manager 108, metadata data store 113, execution platform 110, and data storage 104 may be implemented as a distributed system (e.g., distributed across multiple systems/platforms at multiple geographic locations). Additionally, each of the compute service manager 108, metadata data store 113, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

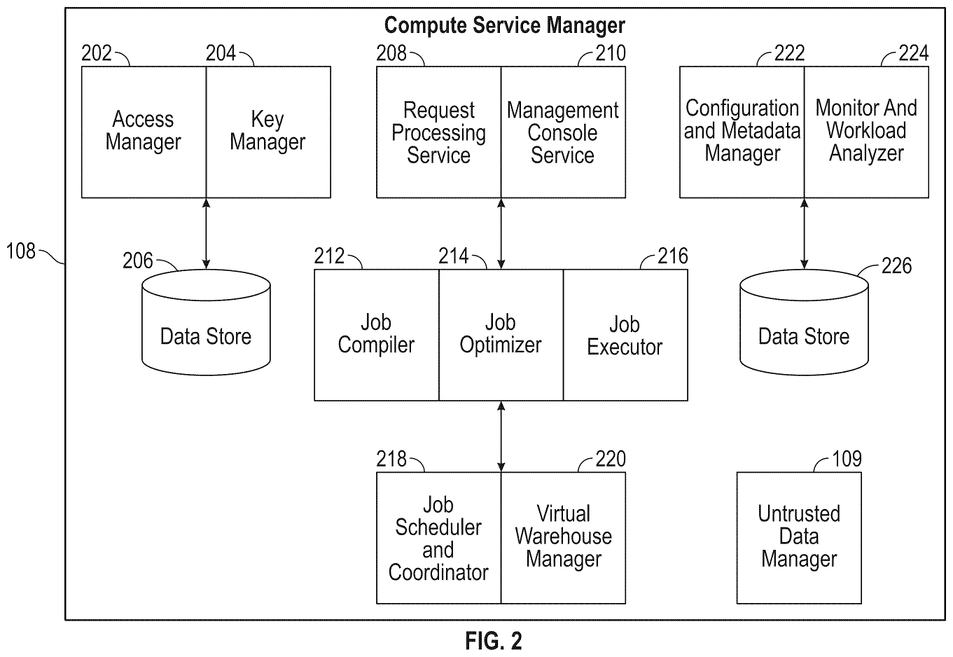

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, the metadata data store 113, or any other storage device or system.

In addition, as mentioned above, the compute service manager 108 includes untrusted data manager 109 that is responsible coordinating receiving untrusted data, such as data from an untrusted zone. Further details regarding the functionality of the untrusted data manager 109 are discussed below.

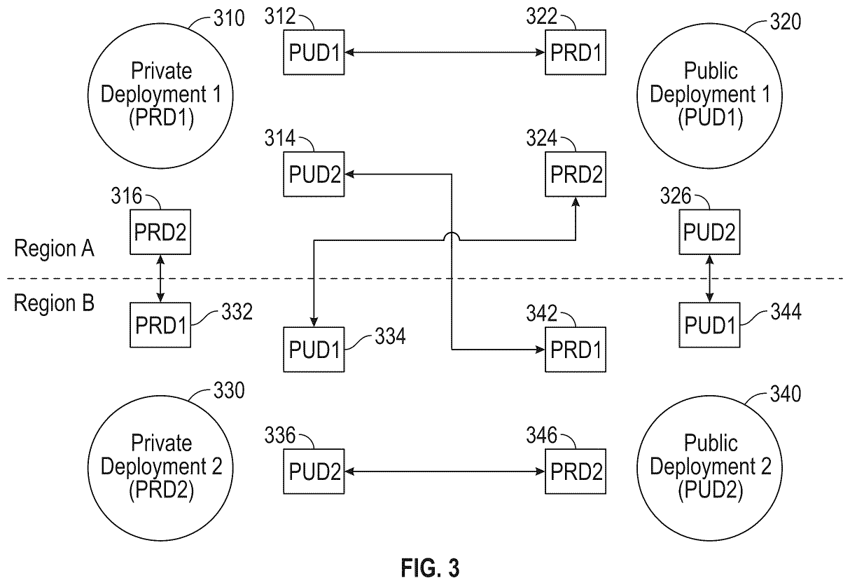

FIG. 3 shows an example multiple deployment environment, according to some example embodiments. The deployments may be part of the same network-based data system (cloud data platform), as described herein. A deployment may include multiple components such as a metadata store, a front-end layer, a load balancing layer, a data warehouse, etc., as discussed above with respect to FIGS. 1-2. The multiple deployment environment may include a plurality of public and private deployments. A public deployment may be implemented as a multi-tenant environment, where each tenant or account shares processing and/or storage resources. For example, in a public deployment, multiple accounts may share a metadata store, a front-end layer, a load balancing layer, a data warehouse, etc. A private (or isolated) deployment, on the other hand, may be implemented as a dedicated, isolated environment, where processing and/or storage resources may be dedicated. Thus, private deployments may offer better security as well as better performance in some configurations.

In FIG. 3, a private deployment 1(PRD 1 ) 310 may be provided in cloud provider region A, and a public deployment 1(PUD 1 ) 320 may also be provided in cloud provider region A. A private deployment 2(PRD 2 ) 330 may be provided in another cloud provider region B, and a public deployment 2(PUD 2 ) 340 may also be provided in cloud provider region B. The cloud provider regions A and B may be different geographic regions, for example. In some embodiments, different cloud providers may operate the deployments in region A and/or region B. In this example, both region A and region B are in trusted zones and therefore are allowed to communicate with each other relatively free of restrictions.

In this example, the different deployments 310, 320, 330, 340 are configured to communicate with each other. For example, they can each send/receive messages to/from each other in a global messaging layer. To do so, each deployment may include deployment objects corresponding to the other communicatively coupled deployments, representing links to the target deployments. For example, PRD1 310 may include a PUD1 deployment object 312, a PUD2 deployment object 314, and a PRD2 deployment object 316. PUD1 320 may include a PRD1 deployment object 322, a PRD2 deployment object 324, and a PUD2 deployment object 326. PRD2 330 may include a PRD1 deployment object 332, a PUD1 deployment object 334, and a PUD2 deployment object 336. PUD2 340 may include a PRD1 deployment object 342, a PUD1 deployment object 344, and a PRD2 deployment object 346.

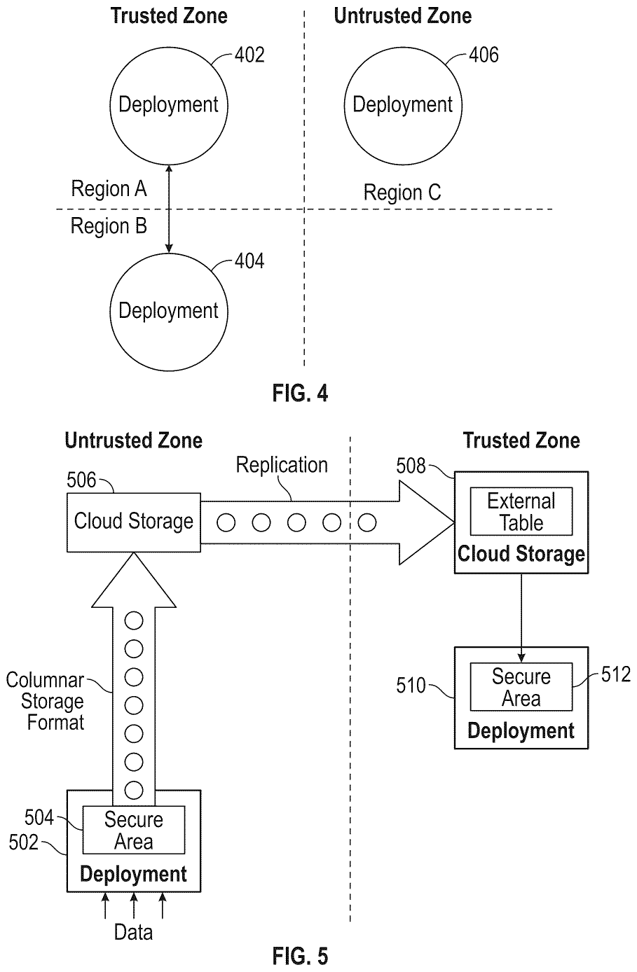

Some deployments may be provided in untrusted zones (e.g., China) where communication to and from those deployments may be severely restricted. FIG. 4 shows an example multiple deployment environment in trusted and untrusted regions, according to some example embodiments. Deployment 402 may be provided in Region A, which is a trusted zone (e.g., United States). Deployment 404 may be provided in Region B, which is also a trusted zone (e.g., Europe). Deployments 402 and 404 may communicate with each relatively free of restrictions.

Deployment 406 may be provided in Region C, which is an untrusted zone (e.g., China). Communication between deployment 406 and deployments 402, 404 may be restricted. For example, a security barrier (e.g., firewall) may be erected to restrict communication to and from deployment 406. Next, techniques to facilitate data communication with deployments in untrusted zones are described.

FIG. 5 shows an example multiple deployment environment with communication between trusted and untrusted zones, according to some example embodiments. A first deployment 502 of a data system may be provided in an untrusted zone. The first deployment 502 may include multiple components such as a metadata store, a front-end layer, a load balancing layer, a data warehouse, etc., as discussed above with respect to FIGS. 1-2.

The first deployment 502 may receive data in different formats. The first deployment 502 may convert the data from the different formats into a common format used by the data system. Processing of the data in the first deployment 502 may be performed in the common format.

The first deployment 502 may include a secure area 504 for interfacing with components outside of the first deployment 502 in the untrusted zone. The secure area 504 may receive data to be exported outside of the first deployment 502 and may convert that data into a columnar storage format (e.g., Parquet format) to facilitate transmission from the untrusted zone to the trusted zone.

The secure area 504 may be communicatively coupled to a first cloud storage location 506. The first cloud storage location 506 may be provided outside of the first deployment 502, but still inside the untrusted zone. Data from the secure area 504 may be transmitted in the columnar storage format to the first cloud storage location 506 and stored in the first cloud storage location 506 to be transmitted from the untrusted zone to the trusted zone.

The first cloud storage location 506 may be communicatively coupled to a second storage location 508, which is located in a trusted zone. The second storage location 508 is provided outside of the data system, but is communicatively coupled to a second deployment 510 of the data system. As discussed above, the first deployment 502 and the second deployment 510 may not be able to communicate directly with each other because of their placements in an untrusted zone and trusted zone, respectively.

The data in the columnar storage format in the first cloud storage location 506 may be replicated and transmitted to the second storage location 508. The replication may involve copying of metadata and other related information.

The received replicated data (and metadata) may be organized in an external table in the second storage location 508. “External table” or “external data” may refer to data stored outside of the data system (e.g., second deployment 510) is not directly managed by the data system, but the data system can perform operations on the external table similar to data stored internally in the data system. The external table may refer to a metadata layer over the second storage location 508, and the external table is used as a virtual reference.

The external table may be provided to the data system in a read-only manner such that the external table is not managed or manipulated by the data system. According to the embodiments disclosed herein, users can use the data system to generate and update metadata about data in the external table, query the external table, and perform other operations, such as security related operations, on the external table.

For example, data in the external table may be scanned for malicious content. A stored procedure of the data system may be executed on the external table to check for malicious content.

After the scanning is performed, and the data system confirms that the data in second storage location 508 is safe, the second deployment 510 may receive the data into the data system. In particular, a secure area 512 in the second deployment 510 may receive the data by way of copying, ingestion, or other suitable data transfer techniques. The second deployment 510 may then treat the received data as trusted data. The second deployment 510 may convert the data into the common format of the data system. In some examples, the second deployment may transmit the received data to other components in the data system, such as a data analytics engine, for different types of processing and analytics.

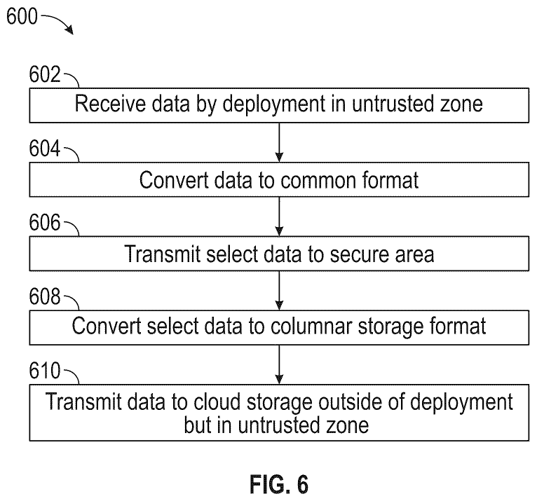

FIG. 6 is a flow diagram of a method 600 for exporting data from an untrusted zone, according to some example embodiments. In some examples, method 600, or portions thereof, can be performed by a deployment (first deployment 502) of a data system in an untrusted zone.

At operation 602, data is received by the deployment in the untrusted zone. The data may be received from different sources. The data may be provided in different file formats. At operation 604, the received data is converted into a common format used by the data system. The data is stored and maintained in the deployment using the common format, as described above with reference to FIGS. 1-2. The deployment can perform operations, such as execute queries, on the data in the common format, as described above.

At operation 606, data to be exported is selected and transmitted to a secure area provided in the deployment. At operation 608, the data to be exported is converted to a columnar storage format (e.g., Parquet format) to facilitate transmission from the untrusted zone to the trusted zone. At operation 610, the data is transmitted from the deployment to a cloud storage location outside the data system but still in the untrusted zone. From the cloud storage location, the data can be replicated and transmitted to another cloud storage location in the trusted zone (but still outside the data system), using cloud storage to cloud storage replication technique as described herein. The replication is performed on the data in the columnar storage format.

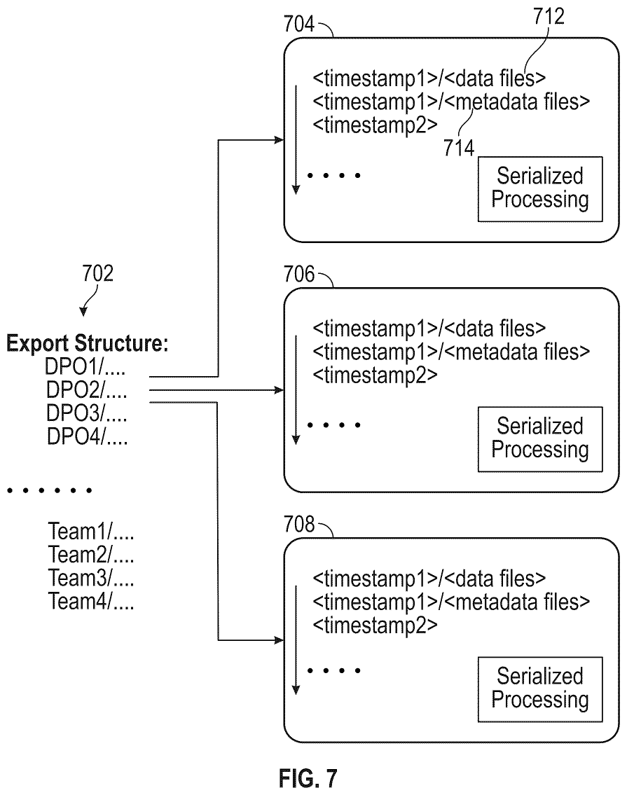

FIG. 7 shows an example of a columnar storage format conversion, according to some example embodiments. Data 702 is provided in the common format of the data system for exportation. Data 702 may include data persistent objects (DPOs). Subsets of data 702 may be arranged in a packet in the columnar storage format. For example, packet 704 may include a first subset of data 702, packet 706 may include a second subset of data 702, and packet 708 may include a third subset of data 702. The packets 704-708 are serialized. Each packet may include table data and metadata files. For example, packet 704 may include a first set of table data files 712 associated with a first timestamp and a first set of metadata files 714 corresponding to the first set of table data files 712.

Packet 704 may also include other data files associated with different timestamps and corresponding metadata files. Each packet is independent of other packets. For example, data in packet 704 may not include any reference or pointer to data in any other packet. The serialized data in the packets can then be replicated and transmitted to the cloud storage location in the trusted zone. The data packets may be encrypted and a checksum property for the encryption may be inserted into the metadata files.

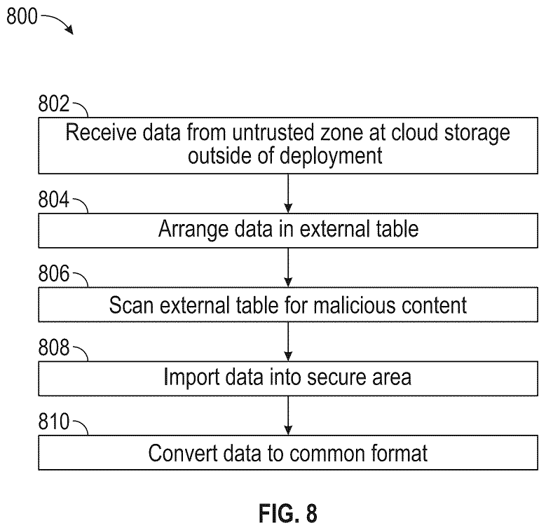

FIG. 8 is a flow diagram of a method 800 for importing data from an untrusted zone, according to some example embodiments. In some examples, method 800, or portions thereof, can be performed by a deployment (second deployment 510) of a data system in a trusted zone.

At operation 802, data from the untrusted zone is received at a cloud storage location. The data may be received using a custom replication process, as described above. The cloud storage location is external to the data system (e.g., deployment 510). A checksum operation may be performed to verify data integrity. The received data may be provided in a columnar storage format, as described above.

At operation 804, the data may be arranged in an external table in the cloud storage location. The external table may be a metadata layer generated by the deployment in the trusted zone in the external cloud storage location. For example, a computing device (e.g., compute service manager 108 as described above) from the deployment in the data system may generate the metadata layer.

For example, the computing device may receive read access to a source directory in the external cloud storage location. The computing device is associated with the data system (e.g., second deployment 510) that is separate from the external cloud storage location. The computing device defines the external table based on the source directory. The computing device may connect the data system to the external table such that the data system has read access for the external table but does not have write access for the external table. The computing device generates metadata for the external table, the metadata including information about data stored in the external table. The computing device may receive a notification that a modification has been made to the source directory, the modification including one or more of an insert, a delete, or an update. The computing device may then refresh the metadata for the external table in response to the modification being made to the source directory.

The computing device may receive an indication of a hierarchical structure in a source directory, the hierarchical structure defining folders and subfolders for data in the source directory. The computing device may also receive an indication of a partitioning structure for data in the source directory. The computing device may define partitions in an external table based on where files are uploaded within the hierarchical structure and further based on the partitioning structure.

At operation 806, data in the external table is scanned for malicious content. Arranging the data in the external table allows for more efficient scanning by the data system. For example, a stored procedure in the data system may be executed for scanning the data in the external table for malicious content. If malicious content is detected, the data remains isolated in the cloud storage location and does not enter the data system (e.g., second deployment 510).

If no malicious content is detected, at operation 808, data is imported into a secure area of the deployment (e.g., secure area 512). For example, the data may be copied or ingested into the secure area. The secure area may correspond to a secure account in the data system, which does not have access to any other account in the data system. That is, the data remains isolated from other components in the data system. This framework provides an added layer of security in case the data gets compromised.

At operation 810, the data is converted from the columnar storage format into the common format of the data system. From the secure area, the data may then be shared with other components and/or deployments of the data system in the trusted zone.

In view of the disclosure above, various examples are set forth below. It should be noted that one or more features of an example, taken in isolation or combination, should be considered within the disclosure of this application.

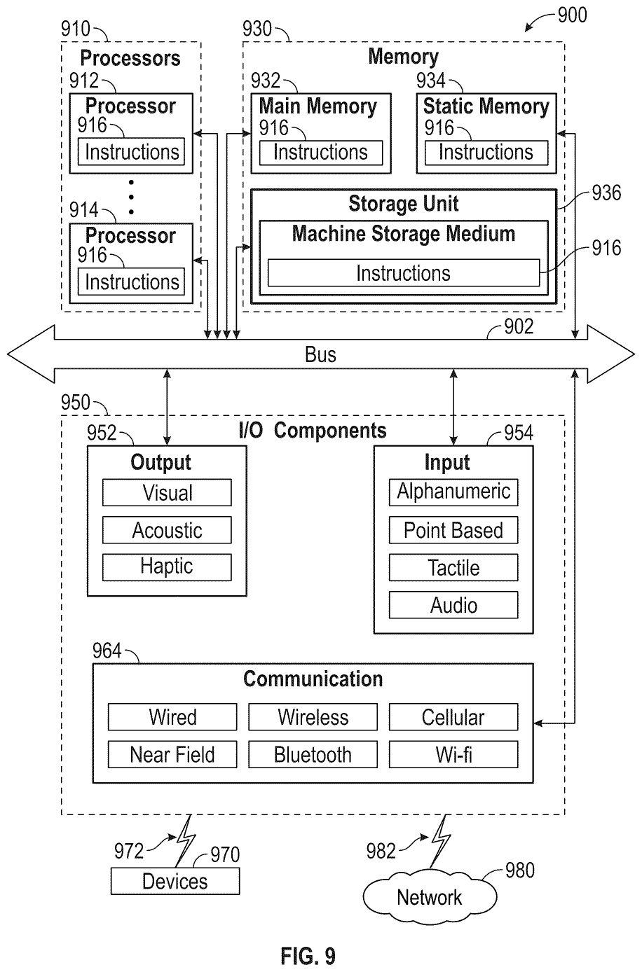

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., a software, a program, an application, an applet, an app, or other executable code) for causing the machine 900 to perform any one or more of the methodologies discussed herein may be executed. For example, the instructions 916 may cause the machine 900 to execute any one or more operations of the methods described herein. As another example, the instructions 916 may cause the machine 900 to implement any one or more portions of the functionality illustrated in any one of FIGS. 1-5. In this way, the instructions 916 transform a general, non-programmed machine into a particular machine that is specially configured to carry out any one of the described and illustrated functions of the cloud data platform 102 such as the compute service manager 108 (or a component thereof such as the untrusted data manager 109) or an execution node of the execution platform 110.

In some embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 includes processors 910, memory 930, and I/O components 950 configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 914 and a processor 912 that may execute the instructions 916. The term “processor” is intended to include multi-core processors 910 that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core processor), multiple processors with a single core, multiple processors with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 include components to receive input, provide output, produce output, transmit information, exchange information, capture measurements, and so on. The specific I/O components 950 that are included in a particular machine 900 will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, and other communication components to provide communication via other modalities. The devices 970 may be another machine or any of a wide variety of peripheral devices (e.g., a peripheral device coupled via a universal serial bus (USB)). For example, as noted above, the machine 900 may correspond to any one of the compute service manager 108, the execution platform 110, and the devices 970 may include the data store 206 or any other computing device described herein as being in communication with the cloud data platform 102 or the data storage 104.

The various memories (e.g., 930, 932, 934, and/or memory of the processor(s) 910 and/or the storage unit 936) may store one or more sets of instructions 916 and data structures (e.g., software) embodying or utilized by any one or more of the methodologies or functions described herein. These instructions 916, when executed by the processor(s) 910, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the method 300 may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.
Example 1. A method comprising: receiving, at a cloud storage location outside of a network-based data system, a set of data from an untrusted zone; arranging, at the cloud storage location, the set of data in an external table; scanning, at the cloud storage location, the external table for malicious content; importing the data into a secure area of the network-based data system based on no malicious content being detected; and converting the imported data into a common format of the network-based data system.
Example 2. The method of example 1, wherein the secure area is isolated from other accounts in the network-based data system.
Example 3. The method of any of examples 1-2, wherein the set of data is in columnar storage format.
Example 4. The method of any of examples 1-3, wherein the set of data comprises table data and metadata relevant to the table data in serialized packets.
Example 5. The method of any of examples 1-4, wherein arranging the set of data in the external table comprises: generating a metadata layer over the set of data in the cloud storage location outside of the network-based data.
Example 6. The method of any of examples 1-5, wherein the scanning is performed by executing a stored procedure on the external table by the network-based data system.
Example 7. The method of any of examples 1-6, wherein the set of data is received from another cloud storage location in the untrusted zone, wherein the another cloud storage location received the set of data from a deployment of the network-based data system in the untrusted zone.
Example 8. A system comprising: one or more processors of a machine; and a memory storing instructions that, when executed by the one or more processors, cause the machine to perform operations implementing any one of example methods 1 to 7.
Example 9. A machine-storage medium embodying instructions that, when executed by a machine, cause the machine to perform operations implementing any one of example methods 1 to 7.

What is claimed is:

1. A system comprising:
at least one hardware processor; and
at least one memory storing instructions that cause the at least one hardware processor to perform operations comprising:
receiving, at a cloud storage location outside of a network-based data system, a set of data from an untrusted zone;
arranging, at the cloud storage location, the set of data in an external table;
scanning, at the cloud storage location, the external table for malicious content;
importing the data into a secure area of the network-based data system based on no malicious content being detected; and
converting the imported data into a common format of the network-based data system.

2. The system of claim 1, wherein the secure area is isolated from other accounts in the network-based data system.

3. The system of claim 1, wherein the set of data is in columnar storage format.

4. The system of claim 3, wherein the set of data comprises table data and metadata relevant to the table data in serialized packets.

5. The system of claim 1, wherein arranging the set of data in the external table comprises:
generating a metadata layer over the set of data in the cloud storage location outside of the network-based data.

6. The system of claim 1, wherein the scanning is performed by executing a stored procedure on the external table by the network-based data system.

7. The system of claim 1, wherein the set of data is received from another cloud storage location in the untrusted zone, wherein the another cloud storage location received the set of data from a deployment of the network-based data system in the untrusted zone.

8. A method comprising:
receiving, at a cloud storage location outside of a network-based data system, a set of data from an untrusted zone;
arranging, at the cloud storage location, the set of data in an external table;
scanning, at the cloud storage location, the external table for malicious content;
importing the data into a secure area of the network-based data system based on no malicious content being detected; and
converting the imported data into a common format of the network-based data system.

9. The method of claim 8, wherein the secure area is isolated from other accounts in the network-based data system.

10. The method of claim 8, wherein the set of data is in columnar storage format.

11. The method of claim 10, wherein the set of data comprises table data and metadata relevant to the table data in serialized packets.

12. The method of claim 8, wherein arranging the set of data in the external table comprises:
generating a metadata layer over the set of data in the cloud storage location outside of the network-based data.

13. The method of claim 8, wherein the scanning is performed by executing a stored procedure on the external table by the network-based data system.

14. The method of claim 8, wherein the set of data is received from another cloud storage location in the untrusted zone, wherein the another cloud storage location received the set of data from a deployment of the network-based data system in the untrusted zone.

15. A machine-storage medium embodying instructions that, when executed by a machine, cause the machine to perform operations comprising:
receiving, at a cloud storage location outside of a network-based data system, a set of data from an untrusted zone;
arranging, at the cloud storage location, the set of data in an external table;
scanning, at the cloud storage location, the external table for malicious content;
importing the data into a secure area of the network-based data system based on no malicious content being detected; and
converting the imported data into a common format of the network-based data system.

16. The machine-storage medium of claim 15, wherein the secure area is isolated from other accounts in the network-based data system.

17. The machine-storage medium of claim 15, wherein the set of data is in columnar storage format.

18. The machine-storage medium of claim 17, wherein the set of data comprises table data and metadata relevant to the table data in serialized packets.

19. The machine-storage medium of claim 15, wherein arranging the set of data in the external table comprises:
generating a metadata layer over the set of data in the cloud storage location outside of the network-based data.

20. The machine-storage medium of claim 15, wherein the scanning is performed by executing a stored procedure on the external table by the network-based data system.

21. The machine-storage medium of claim 15, wherein the set of data is received from another cloud storage location in the untrusted zone, wherein the another cloud storage location received the set of data from a deployment of the network-based data system in the untrusted zone.
